(19) United States
(12) Patent Application Publication
(10) Pub. No.: US 2008/0159311 A1
(43) Pub. Date: Jul. 3, 2008

(54) Method of Providing Data

(75) Inventors: Ricardo Martinotti, Savona (IT); Andrea Corti, Varazze (IT); Raoul Fiorone, Genova (IT)

Correspondence Address: COATS & BENNETT, PLLC, 1400 Crescent Green, Suite 300, Cary, NC, 27518, US

(73) Assignee: ERICSSON AB, Stockholm (SE)

(21) Appl. No.: 11/829,498

(22) Filed: Jul. 27, 2007

(30) Foreign Application Priority Data
Dec. 29, 2006 (EP) PCT/EP2006/012601

(51) Int. Cl. H04L 12/56

(52) U.S. Cl. 370/401

(57) ABSTRACT

A method of providing data from a first network 100 to a second network wherein a first PEJ and a second PEK node are provided in the first network 100 and are each capable of supplying data to the second network, wherein:
i. at any one time one of the first PEJ and second PEK nodes provides data to the second network; and
ii. the first PEJ and second PEK nodes are arranged to communicate with one another such that the other of the nodes can provide data to the second network if a fault is detected, wherein the communications between the first and second node allow a fault to be detected.

### FIELD OF INVENTION

The present invention relates to a method of providing data and related apparatus. In particular, but not exclusively, the invention relates to a dual homing redundancy protocol implemented in a homing configuration joining a first network to a second network.

### BACKGROUND OF INVENTION

It is commonplace to build VPLS (Virtual Private LAN Service) in Ethernet over MPLS (MultiProtocol Label Switching) networks, by establishing pseudo-wires between numerous customer locations spanning an existing network. This may provide a multipoint-to-multipoint connectivity and simulate the existence of a LAN. As is the case in any such network it is desirable to build in resiliency, such that if there is a fault on one part of the network, the remaining network can adapt to this fault, and thus not isolate the customer removing their connection to the network. Furthermore, during multicast or broadcast situations it is a consideration of modern network standards to reduce looping of packets (i.e. the same packets being forwarded indefinitely within the network, without reaching the destination, and thus causing congestion) and frame duplication (i.e. the information arriving twice at a destination equipment).

Several homing configurations are known. As opposed to “Single Homing (also known as Single Homing single attach, i.e. with no protection)” which has a single connection between a Provider Edge (PE) node on a first network and a Customer Edge (CE) node on a second network, both “Single homing with link protection (also known as Single Homing dual attach)” and “Dual Homing” offer resilience in the network by having two or more paths. Whereas in “Single homing with link protection” two or more paths are provided between the same CE node and PE node, Dual Homing is implemented by having a CE that is connected to more than one PE, and thus has the advantage that not only are two or more paths provided in the case of failure on one path, but two or more PE nodes are provided in case of failure on one PE node. Therefore in such Dual Homing configurations failure on either a path or a PE node can be overcome by using a secondary path and a secondary PE node for transmission of data.

As will be readily appreciated a VPLS is a method to implement a Level 2 VPN inside an MPLS network. Where there is provided a CE node connected to a PE node, the CE node may be managed either by the customer (customer's equipment) or by the provider (provider's equipment of an Ethernet network, e.g. in the case of an overlay network). It is desirable that the Customer need not manage or have any influence on any aspect of the VPLS/MPLS network since this could affect the overall network.

Networks using Spanning Tree Protocol (STP) and its derivatives can be implemented to prevent frame looping and to provide network resilience. However in the case where the interface is a UNI (User-to-Network Interface), the Provider is not required to peer the Bridge Protocol Data Units (BPDUs) of the CE node but to either discard them or forward (tunnel) them as normal Ethernet Service Data Units (SDUs) within the VPLS. Therefore in such cases when the customer can have an influence on the Provider network, this can turn into undesirable behaviours or network instability; if instead the control of the providing service and stand by resources is under the complete control of the Provider, all the Operation, Administration and Maintenance (OAM) features can be managed thus giving a better service to the customer than otherwise might be the case.

As will be readily appreciated Spanning Tree Protocol and its derivative require network components (such as CE and PE nodes) that participate in the Spanning Tree within a Dual Homing configuration to be taken account of, and to be involved, in any topology change. It is therefore apparent that the generic behaviour of STP to remove frame looping and duplication is not suited to homing configurations, and in particular Dual Homing arrangements, where one node, namely the CE node, may not be removed from decision making. In addition customer equipment controlled CE nodes would be required to communicate BPDUs through PE nodes, reducing valuable bandwidth on the path between them.

### SUMMARY OF INVENTION

According to a first aspect of the invention there is provided a method of providing data from a first network to a second network wherein a first and a second node are provided in the first network and are each capable of supplying data to the second network, wherein:
i. at any one time one of the first and second nodes will provide data to the second network; and
ii. the first and second nodes are arranged to communicate with one another such that the other of the nodes may provide data to the second network if a fault is detected.

Such a method is advantageous as it allows the first network to operate and provide resilience to the second network without any influence from the second network on the operation of the first network.

At least one of and generally both of the first and second nodes may send to the other of the nodes, from time to time, a query message. Generally the node sending the message will wait, may be for a predetermined time, for a reply from the other node. An advantage of such sending and receiving of messages is that it can be used to determine whether the other node is still functioning; i.e. if a message is sent and no reply is received it may be inferred that the other node is no longer operational.

Generally, one of the nodes is designated a Providing Service Node (PSN) and supplies data to the second network; i.e. it is in an active mode. The other node may be thought of a Standby node which does not generally supply data to the second network whilst the PSN is functioning. Such an arrangement helps to prevent looping and duplicate data packets being sent to the second network.

Generally, if one of the nodes does not receive a response to the query message then the node that sent the message will become the Providing Service Node (PSN) and supply data to the second network. Such a method helps to ensure resilience if a node were to fail.

Each of the first and second nodes will generally send a communication to the other node if that node determines that a path linking the node to the second network has failed. Such a communication allows resiliency should a path fail.

Each of the first and second nodes, on receipt of the communication indicating that the path has failed, may become the Providing Service Node (PSN). That is, if it is determined that the path linking a node to the second network has failed the other of the nodes may be arranged to automatically supply data to the second network.

Each of the first and second nodes may be to send a message, generally across the first network, if it switches from being a Providing Service node to a Standby node. Such a method is convenient as it will allow the first network to route data more efficiently that otherwise would be the case.

The first and second nodes may be interchangeable. Such a method is convenient as it reduces the complexity of the first network since different types of node need not be provided.

According to a second aspect of the invention there is provided a network node comprising a receiver and a transmitter respectively arranged to receive and transmit data to and from a first and a second network to which the node can be connected, the node having the capability of receiving data from the first or second network via the receiver and forwarding that data to or from the other of the first and second networks, the node also having the capability of communicating with at least one other node by sending and transmitting communications, the communications being processed when received in order to determine whether data should be forwarded between the first and the second network.

Such a node can help to provide resilience to a connection of the second network to the first network.

The node is capable of implementing any of the optional features of the method according to the first aspect of the invention.

According to a third aspect of the invention there is provided a network comprising at least two nodes according to the second aspect of the invention which are arranged to communicate with one another.

A network according to the second aspect of the invention in which the two nodes are arranged to communicate with one another in order to provide the method of the first aspect of the invention.

The network may be arranged to provide a Virtual Private LAN Service (VPLS). The network may be a MultiProtocol Label Switching (MPLS) network which is likely to be connected as a mesh network, whereby connectivity is multipoint-to-multipoint.

A node of the second aspect of the invention may be thought of as being a Provider Edge node, which allows a second network to be connected. Thus, the Provider Edge node may be considered as the connecting, or joining point of a Customer Network and a Provider Network.

The link between Customer Network and the Provider Network (i.e. the attachment to the Provider Edge node) will generally not be part of the MPLS network, and may comprise only one possible path between Customer Network and Provider Edge node.

According to a fourth aspect of the invention there is provided a machine readable medium containing instructions which when read on a machine cause that machine to function as the node of the second aspect of the invention.

According to a fifth aspect of the invention there is provided a machine readable medium containing instructions which when read onto a machine cause that machine to provide at least a part of the method of the first aspect of the invention.

The machine readable medium referred to in any of the above aspects of the invention may include: a floppy disk, a CD ROM, a DVD ROM/RAM (including −R/−RW, +R/+RW, HD and BLU ray), a memory (including SD cards, compact flash cards, XD cards, memory per se, hard drives, Memory Sticks™), tape, any form of magneto optical storage, transmitted signals (including Internet downloads, FTP transfers, etc), a wire.

### BRIEF DESCRIPTION OF THE DRAWINGS

There now follows by way of example only a detailed description of the present invention with reference to the accompanying drawings in which:

FIG. 1 shows a VPLS that is used by an embodiment of the present invention;

FIG. 2 shows the various “Homing” configurations employed in the prior art;

FIG. 3 shows a schematic of a Dual Homing configuration;

FIG. 4 shows a general Finite State Machine (FSM) of each PE node implementing an embodiment of the present invention; and

FIG. 5 shows an equipment Finite State Machine (FSM) of a PE node implementing an embodiment of the present invention.

### DETAILED DESCRIPTION OF THE DRAWINGS

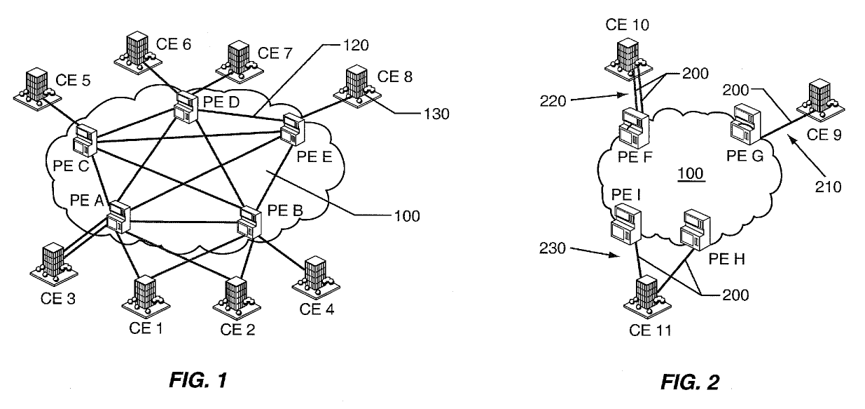

FIG. 1 shows a network on which there is provided a VPLS (Virtual Private LAN Service) 100. The VPLS 100 may be provided on a MPLS (Multiprotocol Label Switching) network or any other suitable network protocol (e.g. IP networks). The VPLS 100 comprises a plurality of Provider Edge nodes PE A to E. Each Provider Edge node PE is in communication with each of the other Provider Edge nodes PE via pseudo-wires 120. The Provider Edge nodes PE may be thought of as point of connection to the VPLS 100 for customer wishing to send data across the network.

The Provider Edge node and the Customer Edge node may each be provided by any suitable device such as a Switch, an Optical Switch, a Router or the like.

The Provider Edge nodes PE are also in communication with Customer Edge nodes CE 1 to 8 which are external to the VPLS 100. The network is arranged such that data, including broadcast or multicast data, may be communicated to each Customer Edge node CE across the VPLS 100. It will be readily appreciated that the Provider Edge nodes PE, being part of the VPLS 100, may be controlled by equipment owned by the network operator. However, the Customer Edge nodes CE are not generally controlled by the network operator, nor are networks connected to these Customer Edge nodes, and as such may be thought of as being controlled by customers to the network. In such an arrangement the interface between the Provider Edge nodes PE and Customer Edge nodes CE can be considered to be a User to Network Interface (UNI). The VPLS network 100 may be thought of as being a first, or Provider, network and the network connected to the Customer Edge node CE may be thought of as being a second, or Customer, network.

In an alternative embodiment to that shown, the Provider Edge node may be arranged to control, and arbitrate roles for, the Customer Edge nodes CE. In such an arrangement the interface between Provider Edge node PE, and Customer Edge node CE can be considered to be a Network-to-Network Interface (NNI), given that the Network provider may have control of the Customer Edge node CE too.

As will be appreciated, within the MPLS network resiliency can be assured in several ways using techniques available in the prior art, and therefore it may be readily achievable within the VPLS 100 as well. By contrast, resiliency between each Customer Edge node CE and one or more connected Provider Edge nodes PE may be provided by several homing configurations which are discussed below.

FIG. 2 shows several of these configurations. Single homing 210 comprising one homing path 200 connecting a Provider Edge node PE G and a Customer Edge node CE 9. Such an arrangement provides no resiliency, where if the single homing path 200, or Provider Edge node PE G fails, communication is lost between the VPLS 100 and the Customer Edge node CE 9 and therefore any devices connected to the VPLS 100 will not be able to receive data.

An alternative set up is to use single homing with link(s) protection 220, which comprises two or more homing paths 200, all of which are connected between one Provider Edge node PE F and one Customer Edge node CE 10. Such an arrangement provides some resiliency, where if the single homing path 200 fails, communication is maintained between the VPLS 100 and the Customer Edge node CE 10 on a subsequent homing path 200. If however the Provider Edge node PE F fails, then communication is lost between the VPLS and the Customer Edge node CE 10 and therefore any devices connected to the VPLS 100 will not be able to receive data from and send data to Customer Edge node CE 10.

As a further alternative a dual homing 230 may be used which comprises two or more homing paths 200, each of which connects the Customer Edge node CE 11 to a different Provider Edge node and in this case PE H and PE I connect the Customer Edge node CE11 to the VPLS 100. Thus, a first node (e.g. PE H) and a second node (e.g. PEI) connect CE11 to the VPLS 100. As will be readily appreciated, such an arrangement is able to provide resiliency against the failure of a homing path 200, as well as at either of the Provider Edge nodes PE H and PE I. Although, in the Figure, only two Provider Edge nodes are shown connected to Customer Edge node CE11 more Provider Edge nodes could be connected to Customer Edge node CE11. There may for example be 3, 4, 5, 6, 7, 8, 9, 10 or more Provider Edge nodes connected to Customer Edge node CE11.

In the present embodiment the Provider Edge nodes PE, which are connected to a Customer Edge node CE using a Dual Homing configuration, (e.g. Provider Edge nodes are arranged to communicate with one another in order to detect a failure either in the other of the Provider Edge nodes in the Dual Homing arrangement, or in a homing path 200 between the Customer Edge node CE and any of the Provider Edge nodes PE. In this arrangement the Customer Edge node CE does not require configuration to recognise failures. The protocol used in such an arrangement may be considered a Dual Homing Redundancy Protocol (DHRP).

There may be considered at least two modes of DHRP when the Provider Edge nodes PE are arranged to evaluate failures at either a Provider Edge node PE or a homing path 200. In the first of these modes, so termed “fixed role”, the Provider Edge node PE is arranged to either be providing data (i.e. provide service) for any Customer Edge nodes CE to which it is connected (there may be a plurality), or to be in standby mode and as such not provide data to any of the nodes to which it is connected. In the case where the Provider Edge node PE is in standby mode, the Customer Edge nodes CE will maintain communication with the VPLS 100 by receiving communication from the alternative Provider edge node PE which is not in standby mode (i.e. it is providing data). In the event of a failure in association with the Provider Edge node PE which is providing service, then that node stops supplying data to each Customer Edge node to which it is connected, and the other Provider Edge node PE, which was in standby, will therefore provide data (i.e. it is providing service) for each Customer Edge node to which it is connected.

In an alternative mode, so termed ‘on a per Customer Edge basis role’, each Provider Edge node PE is arranged such that it may provide service for one or more Customer Edge nodes CE, while being in standby for other Customer Edge nodes CE. In this mode a Provider Edge node PE may stop supplying data to some Customer Edge nodes whilst continuing to supply data to other Customer Edge nodes CE.

The ‘fixed role’ mode may be easier to implement, although it may not be resilient to mixed homing path failures (i.e. one failure between a Customer Edge node CE and the Provider Edge node PE which is providing service and one concomitant failure between another Customer Edge node CE and the other Provider Edge node PE which is in standby), while ‘on a per CE basis role’ may require more computing resources, but is resilient against mixed homing path 200 failures.

In each DHRP arrangement data signals are transmitted between relevant Provider Edge nodes PE such that the Provider Edge nodes PE may recognise and adapt to failures in the dual homing arrangement. That is the node in the DHRP arrangement communicate with one another. Several such signals may be used as will be discussed herein.

Such signals include:
1 Hello Message, which may be thought of as a query message and which is transmitted from time to time, between Provider Edge nodes PE, in order to determine Provider Edge node PE failure. Generally the Hello messages will be transmitted at intervals, perhaps at substantially fixed intervals;
2 Customer Link State Message from each Provider Edge node PE toward other Provider Edge nodes PE, in order to indicate homing path 200 failure;
3 Topology Change Message from a Provider Edge node PE, changing from providing service to stand-by, toward all Provider Edge nodes PE involved in that VPLS (for each VPLS), in order to clear MAC address entries in Forwarding tables, without waiting for the refresh due to ageing (optional behaviour, but it can provide significant optimisation in some applications, e.g. video services). That is a communication is sent to the first network indicating the change;
4 APS Message from a Provider Edge node PE to a companion Provider Edge node PE, in case of Forced or Manual commands from a Network Operator.

It will be readily appreciated to a person skilled in the art that such messages signals will generally comprise a plurality of data. Table 1 details an example of the DHRP signalling message format of the present embodiment when considering Ethernet Layer as a communication channel.

TABLE 1
Signalling message format

| | |
|---|---|
| 6 | DMAC |
| 6 | SMAC |
| 2 | EtherType (DHRP) |
| 1 | CE_node CE ID |
| 1 | OpCode |
| . . . | OpCode specific fields |
| . . . | Padding (if required) |
| 4 | FCS |

The various fields within the message format are detailed below:
DMAC: Destination MAC address
SMAC: Source MAC address
EtherType (DHRP): DHRP Ethernet Type that uniquely identifies DHRP frames.
Customer Edge node CE ID: An 8-bit field that identifies the “dual homed customer equipment” interested by the protection. If “Fixed role” is used, Value is 0x00; if “On a per CE basis role” is used, Value ranges from 0x01 to 0xFF.
OpCode: Identifies DHRP frame type. DHRP frames with unknown OpCodes are silently discarded. OpCodes may be set for those signals detailed above such as:
   Hello Message: 0x01;
   Customer Link State Message: 0x02;
   Topology Change Message: 0x03;
   APS Message: 0x04;
   Other messages etc
OpCode specific fields: Further information can be carried, if needed by each message, in Type-Length-Value (TLV) format:
   Type: a 8-bit field that identifies the information contained into the Value field. It ranges from 0x00 to 0xFF. Types defined in this document are:
      VPLS ID: 0x01 (used to identify VPLS instance, to be used within Topology Change Message);
      APS_ID: 0x04
      Other types etc
   Length: a 16-bit field that identifies the length of the Value field. It ranges from 0x000 to 0x400.
   Value: a variable length field containing variable information. In case APS_ID the Value field takes the following significance:
      0x02: Forced switch
      0x01: Manual switch
FCS: Frame Checksum Sequence

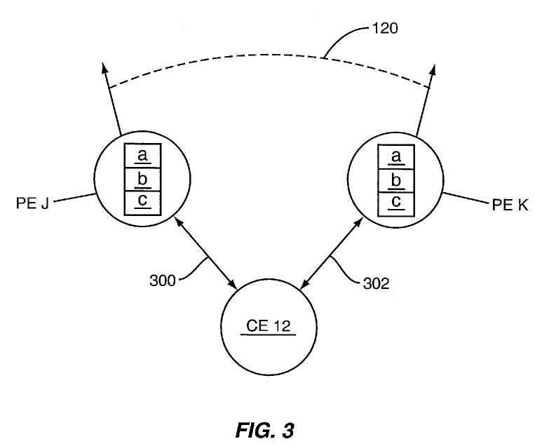

FIG. 3 shows and embodiment of present invention whereby DHRP is implemented. In this arrangement the VPLS network 100 is able to operate STP (Spanning Tree Protocol) or the like, while the VPLS network operator (i.e. the Provider) is able to manage resilience without the requirement of the control or knowledge of the Customer Edge node CE.

Here two homing paths 300, 302 are provided and connect a Customer Edge node CE 12 to two separate PE nodes PE J and PE K. PE-J connects to the Customer Edge node CE 12 via the homing path 300, while the Provider Edge node PE-K connects to the Customer Edge node CE 12 via the homing path 302. Both Provider Edge node PE-J and Provider Edge node PE-K are connected via a pseudo-wire 120 of the VPLS 100 and thus are able to communicate with each other.

Each of the Provider Edge nodes PE-J, PE-K is capable of communicating with both the first network (i.e. the VPLS 100) and also the second network (i.e. the Customer Edge node CE12) and as such each comprises receivers a and transmitters b capable of communicating with each of these networks. Each node also comprises a processor c arranged to process communications received by the receiver a and to generate communications for transmission by the transmitter b.

Each Provider Edge node PE may connect to any number of Customer Edge nodes CE via alternative homing paths 200; i.e. although FIG. 3 shows only a single Customer Edge node CE12 connected to each of the Provider Edge nodes PE J, PE K it is likely that a plurality of Customer Edge nodes CE 12 would be connected to each of the Provider Edge nodes PE J, PE K. Similarly a Customer Edge node CE may be connected to any number of Provider Edge nodes PE. As discussed above two alternative configurations of the Provider Edge nodes PE can be envisaged when implementing such Dual Homing and DHRP, namely ‘fixed role’ and ‘on a per Customer Edge basis role’.

By way of example the steps involved in a DHRP used when considering ‘on a per Customer basis role’ are detailed below with reference to FIG. 3.
1. Initiate which Provider Edge node PE it is wished to use as the primary node (this can be either PE J or PE K, communicating on either homing path 300, 302 respectively)—In this example, assume PE J is the primary node, and thus the primary path for communication to the Customer Edge node CE 12 is path 300
2. If there is a Provider Edge node failure at PE J, then the system re-initiates and automatically switches to using Provider Edge node PE K after a node re-start. While if there is a link failure on path 300 then the system automatically switches to using Provider Edge node PE K and PE J goes into Stand-by mode.
3. Now using node PE K and path 302 to communicate data to the Customer Edge node CE 12, if there is a Provider Edge node failure at node PE K, then this is detected by Provider Edge node PE J, as a time-out error (i.e. a reply was not received in a predetermined time) from a “Hello” message, and Provider Edge node PE J comes out of standby and communication is automatically switched to use node PE J. Similarly when there is a failure on path 302, this is detected by Provider Edge node PE K and a “Customer Link State Message” is then communicated to Provider Edged node PE J. This triggers a change of state and Provider Edge node PE J starts providing service; i.e. it becomes the Primary node.
4. If during communication either Provider Edge node PE J or PE K is in standby and fails, then a node restart is initiated, and the system is initialised again.
5. In a similar manner to above, if there is then a failure on Provider Edge node PE K, or path 302 then the system automatically switches to using Provider Edge node PE J.
6. Also manual switch and forced switch commands are provided for maintenance purposes or for all other possible cases in which the network Provider may need to perform actions from the Management System.

During the steps above, both the primary Provider Edge node (i.e. one of either PE J or PE K) and the standby node (i.e. the other one of Provider Edge node PE J or PE K) are in communication with each other via a pseudo-wire path 120, which maybe be itself a protected resource within the MPLS network, and each is arranged to send, from time to time, “Hello” messages to establish if the other PE node PE J or PE K is working. This is done by means of a simple timeout; i.e. if an answer is not received, within a predetermined time, by the Provider Edge node PE J or PE K to a “Hello” message that it has sent then failure is assumed.

Both Provider Edge nodes PE J, PE K also receive “Customer Link State Messages” from the other Provider Edge node, only in the case of a failure on the homing path 200 between the other PE node PE and the CE node CE; i.e. if path 300 fails Provider Edge node PE J sends a “Customer Link State Message” to Provider Edge node PE K and likewise if path 302 fails Provider Edge node PE K sends a “Customer Link State Message” to Provider Edge node PE J.

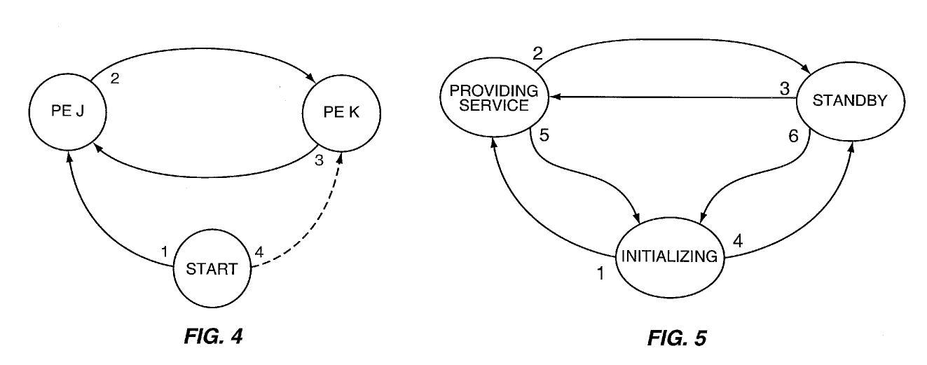

In order to highlight this further FIG. 4 shows a Finite State Machine (FSM) for the DHRP operational mode, while FIG. 5 shows a FSM of the Provider Edge node PE operation, in particular Provider Edge PE J of the above example. Table 2 below shows the state triggers used when using the FSM of FIG. 4, while Table 3 shows the state triggers used when using the FSM of FIG. 5.

TABLE 2
State triggers for FIG. 4

| | | | | | Forced |
|---|---|---|---|---|---|
| | | Node failure | Link failure | Manual switch | switch |
| Trigger | 1 | | | To PE J | |
| | 2 | PE J | 300 | To PE K | 302 |
| | 3 | PE K | 302 | To PE J | 300 |
| | 4 | | | To PE K | |

TABLE 3
State triggers for FIG. 5

| | | Node | Link | Manual | Forced | |
|---|---|---|---|---|---|---|
| | | failure | failure | switch | switch | Hello |
| Trigger | 1 | | | To PE J | | |
| | 2 | | 300 | To PE K | To PE K | |
| | 3 | PE K* | 302** | To PE J | To PE J | |
| | 4 | | | To PE K | | From PE K |
| | 5, 6 | PE J*** | | | | |

*Detected by Hello Message Timeout
**Detected by Customer Link State Message
***After node restart

It will be readily appreciated to a person skilled in the art that in Transport Network terminology a “manual” command does not allow a change of state in the state machine in case of presence of failure related to the destination state, while a “forced” command allows change of state even in a case where there is a presence of failure related to the destination state within the state machine.

In the present embodiment in relation to FIG. 3, the Customer Edge node CE 12 is arranged to receive data from both Provider Edge nodes, PE J and PE K. However both to the Provider Edge nodes PE J and PE K do not provide data at the same time. Indeed one Provider Edge node may be considered a Providing Service Node (PSN), while the other may be considered a Standby node (SBN). As the system is arranged to configure initially on one Provider Edge node, the Providing Service Node may also be considered the Initialising Node (IN).

Detailed below are the propriety actions required by each node:

Providing Service Node (PSN)
Forwards traffic (i.e. data packets) to/from Customer Edge node CE 12 which it receives from the VPLS 100 and are directed to the Customer Edge node CE 12.
Sends Hello Message to SBN/IN
Receives Hello Message from SBN
Receives Customer Link State Messages from SBN
Optionally, when changing state to SBN/IN, sends Topology Change Message to all PE's of VPLS

Stand-By Node (SBN)
Discards traffic (i.e. data packets) to/from Customer Edge node CE 12 which it receives from the VPLS 100 and which are directed to the Customer Edge node CE 12.
Sends Hello Message to PSN
Receives Hello Message from PSN
Receives Customer Link State Messages from PSN

Initializing Node (IN)
Discards traffic (i.e. data packets) to/from Customer Edge node CE 12 which it receives from the VPLS 100 and which are directed to the Customer Edge node CE 12.
Waits for Hello Message from PSN

The use of such a system allows the Provider Edge nodes PE J, PE K to actively control the topology of the connection between the customer network and the provider network without involving the Customer Edge nodes CE 12. Therefore in the present invention the Customer Edge node observes a standard network, while the VPLS 100 may adapt for resiliency to account for failure of a path 300, 302 or a Provider Edge node PE J, PE K. Furthermore as the protocol as detailed is able to manage the resiliency without the input from the Customer Edge node CE 12 frame looping and duplication are avoided, without the requirement to implement STP.

It will be readily appreciated by a person skilled in the art that the embodiment detailed above may be applied to any connection oriented-packet switched network (e.g. to connection oriented Ethernet, like Provider Backbone Transport—PBT—that is being standardized by International Communication Union—Telecom sector ITU-T), where a communication channel is available between the two PE nodes.

Embodiments of the invention may also be thought of as providing a method of providing resilience to a network connection between a first and a second network.

1-27. (canceled)

28. A method of providing data from a first network to a second network wherein a first and a second node are provided in the first network and are each capable of supplying data to the second network, comprising:
at any one time, providing data to the second network from one of the first and second nodes; and
communicating between the first and second nodes to allow a fault to be detected; and
if a fault is detected, providing data to the second network from the other of the first and second nodes.

29. The method of claim 28 wherein communicating between the first and second nodes to allow a fault to be detected comprises at least one of the first and second nodes intermittently sending a query message to the other of the nodes.

30. The method of claim 29 further comprising determining, by the node sending the message, that the other node has failed if a reply from the other node is not received.

31. The method of claim 30 determining that the other node has failed comprises determining that the other node has failed if a reply from the other node is not received within a predetermined time after sending the message.

32. The method of claim 30 wherein providing data to the second network from the other of the first and second nodes comprises providing data to the second network from the node sending the message after it determines that the other node has failed.

33. The method of claim 32 further comprising, once the node supplies data to the second network, sending a communication to the first network indicating that it is supplying data to the second network.

34. The method of claim 28 wherein communicating between the first and second nodes to allow a fault to be detected comprises either of the first and second nodes sending a message to the other node if that node determines that a path linking the node to the second network has failed.

35. The method of claim 34 further comprising, upon receiving a message from the other node indicating that the path has failed, providing data to the second network.

36. The method of claim 35 further comprising, once the node supplies data to the second network, sending a communication to the first network indicating that it is supplying data to the second network.

37. The method of claim 28 wherein each of the first and second nodes is connected to a plurality of second networks.

38. The method of claim 37 further comprising, if one of the first and second nodes determines that a fault has occurred, ceasing to supply data to all of the second networks to which it is connected.

39. The method of claim 37 further comprising, if one of the first and second nodes determines that a fault has occurred, ceasing to supply data to only the second network associated with the detected fault.

40. The method of claim 28 wherein more than two nodes communicate with one another and each of the nodes is capable of supplying data from the first network to the second network.

41. The method of claim 28 further comprising discarding received data that is addressed to the second network by the node that is not sending data to the second network.

42. A network node comprising:
a receiver operative to receive data from a first network and a second network to which the node can be connected;
a transmitter operative to respectively transmit data to the second and first networks;
wherein the node is operative to communicate with at least one other node to determine whether the node should forward received data between the first and the second networks.

43. The node of claim 42 wherein the node is operative to intermittently send a query message to another node in the first network.

44. The node of claim 43 wherein the node is operative to determine that the node to which the query message was sent has failed if no reply is received within a predetermined time after sending the query message.

45. The node of claim 42 operating in a stand by mode in which it does not forward to the second network data it receives that is intended for the second network.

46. The node of claim 42 operating in an active mode in which it forwards to the second network data it receives that is intended for the second network.

47. A network, comprising:
at least two nodes arranged to communicate with one another, each node comprising
a receiver operative to receive data from a first network and a second network to which the node can be connected; and
a transmitter operative to respectively transmit data to the second and first networks;
wherein the node is operative to communicate with at least one other node to determine whether the node should forward received data between the first and the second networks.

48. The network of claim 47 wherein the two nodes are arranged to communicate with one another in order to detect a fault in one node providing data to another network and to provide data to the other network via the other node upon detecting the fault.

49. The network of claim 48 configured to provide a Virtual Private LAN Service (VPLS).

50. The network of claim 48 wherein the network is a Multiprotocol Label Switching (MPLS) network.

51. The network of claim 48 wherein the network is a connection-oriented packet switched network.

52. The network of claim 51 connected as a mesh network, whereby connectivity is multipoint-to-multi point.

53. A machine readable medium containing instructions causing a controller in a network node to perform the steps of:
receiving data from a first network and a second network to which the node can be connected; and
respectively transmitting data to the second and first networks; and
communicating with at least one other node to determine whether the node should forward received data between the first and the second networks.
